(19) United States
(12) Patent Application Publication
(10) Pub. No.: US 2026/0065337 A1
(43) Pub. Date: Mar. 5, 2026

(54) INTELLIGENT INTERNET OFFERS

(71) Applicant: Ergo Offers, Inc., Brooklyn, NY (US)

(72) Inventors: Claire STEPANEK, Brooklyn, NY (US); Vidya KAPADIA, Brooklyn, NY (US); Chardae EDOROR, Brooklyn, NY (US)

(21) Appl. No.: 18/824,200

(22) Filed: Sep. 4, 2024

(51) Int. Cl. G06Q 30/0601; G06Q 30/0201

(52) U.S. Cl. CPC G06Q 30/0611; G06Q 30/0206

(57) ABSTRACT

The present disclosure describes systems and methods that provide intelligent offers for products. The method includes enabling intelligent offers for a target product, identifying one or more intelligent offer rules for the target product, receiving, from a user over a communication network, an offer for the target product, and validating the offer for the target product using the one or more intelligent offer rules, which includes determining to accept the offer for the target product based on comparing the intelligent offer rules to one or more characteristics of the offer and accepting the offer. The offer for the target product is the sole offer from the user for the target product. Determining to accept the offer for the target product is based on the sole offer from the user for the target product.

### TECHNICAL FIELD

Embodiments presented in this disclosure generally relate to network communications. More specifically, one or more embodiments disclosed herein relate to intelligent internet offers.

### BACKGROUND

Many merchants offer products (e.g., goods or services) for sale on the Internet, through purchase environments that are presented to consumers on websites, mobile applications, and other electronically-connected purchase environments. These merchants typically offer the products for sale at a defined price, sometimes including a discount or promotional benefit. But this can lead to a mismatch between the price offered by the merchant, and the price a customer might actually be willing to pay, resulting in wasted transactions, computation, and network traffic stemming from uncompleted sales.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a communication network with intelligent offer validation, according to one embodiment.

FIG. 2 is a block diagram illustrating an intelligence server for intelligent offer validation, according to one embodiment.

FIG. 3 is a message diagram for intelligent offer validation, according to one embodiment.

FIG. 4 is a flowchart illustrating intelligent offer validation, according to one embodiment.

FIG. 5 is a flowchart illustrating validating an offer for intelligent offer validation, according to one embodiment.

FIGS. 6A-B illustrate a user interface for intelligent offer validation, according to one embodiment.

FIG. 7 is a flowchart illustrating training an intelligent offer ML model, according to one embodiment.

FIG. 8 is a flowchart illustrating inferring an intelligent offer using an ML model, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a system that provides intelligent offers for products. According to an embodiment, a method includes enabling intelligent offers for a target product, identifying one or more intelligent offer rules for the target product, receiving, from a user over a communication network, an offer for the target product, and validating the offer for the target product using the one or more intelligent offer rules, which includes determining to accept the offer for the target product based on comparing the intelligent offer rules to one or more characteristics of the offer and accepting the offer. The offer for the target product is the sole offer from the user for the target product. Determining to accept the offer for the target product is based on the sole offer from the user for the target product.

According to another embodiment, a non-transitory computer program product includes one or more non-transitory computer readable media containing, in any combination, computer program code that, when executed by operation of any combination of one or more processors, performs operations including enabling intelligent offers for a target product, identifying one or more intelligent offer rules for the target product, receiving, from a user over a communication network, an offer for the target product, and validating the offer for the target product using the one or more intelligent offer rules, which includes determining to accept the offer for the target product based on comparing the intelligent offer rules to one or more characteristics of the offer and accepting the offer. The offer for the target product is the sole offer from the user for the target product. Determining to accept the offer for the target product is based on the sole offer from the user for the target product.

According to another embodiment, a system includes one or more processors and one or more memories storing a program, which, when executed on any combination of the one or more processors, performs operations, the operations including enabling intelligent offers for a target product, identifying one or more intelligent offer rules for the target product, receiving, from a user over a communication network, an offer for the target product, and validating the offer for the target product using the one or more intelligent offer rules, which includes determining to accept the offer for the target product based on comparing the intelligent offer rules to one or more characteristics of the offer and accepting the offer. The offer for the target product is the sole offer from the user for the target product. Determining to accept the offer for the target product is based on the sole offer from the user for the target product.

### Example Embodiments

Customers can buy products (e.g., goods or services) from a merchant over the Internet using a web browser, software program, mobile application, or other application. Customers can shop online using a variety of different electronic devices, including mobile phones, tablet computers, laptop computers, and desktop computers. A customer can purchase products through an online purchase environment, which typically allows customers to view available products, select desired products, and purchase the products. A customer can complete a transaction by providing a valid method of payment, such as a payment card (e.g., credit card or debit card) or a credential for a payment service.

Typically, however, a merchant sets the price for a given product. The customer must pay the set price if they wish to purchase the product. While this is effective in some circumstances, it has several disadvantages. For example, it is very difficult for merchants to determine the optimal price for a product. A customer may be willing to purchase a product at a lower price than offered, and the merchant may be willing to accept that price, but because the product is only offered at the set price the customer does not purchase the product. The customer loses out on purchasing a desired product and the merchant loses out on a potential sale.

In one embodiment, this could be improved by offering a platform for price negotiation between the customer and merchant. For example, the customer or merchant could identify a starting price, and then the parties could engage in multiple rounds of negotiation to determine whether they can agree to a negotiated price. But this also has significant disadvantages. As one example, for large scale merchants (e.g., merchants selling products to a large number of customers), this negotiation can be computationally burdensome. The back and forth rounds of negotiation create a load balancing challenging for network traffic between users and the merchant (e.g., because of the numerous network transmissions required), and create a computational burden on the merchant to receive, analyze, and respond to user offers. For example, the merchant can use computationally intensive rules or machine learning (ML) based techniques to validate an offer (e.g., determine whether to accept or reject an offer), and so multiple rounds of negotiation can be computationally burdensome.

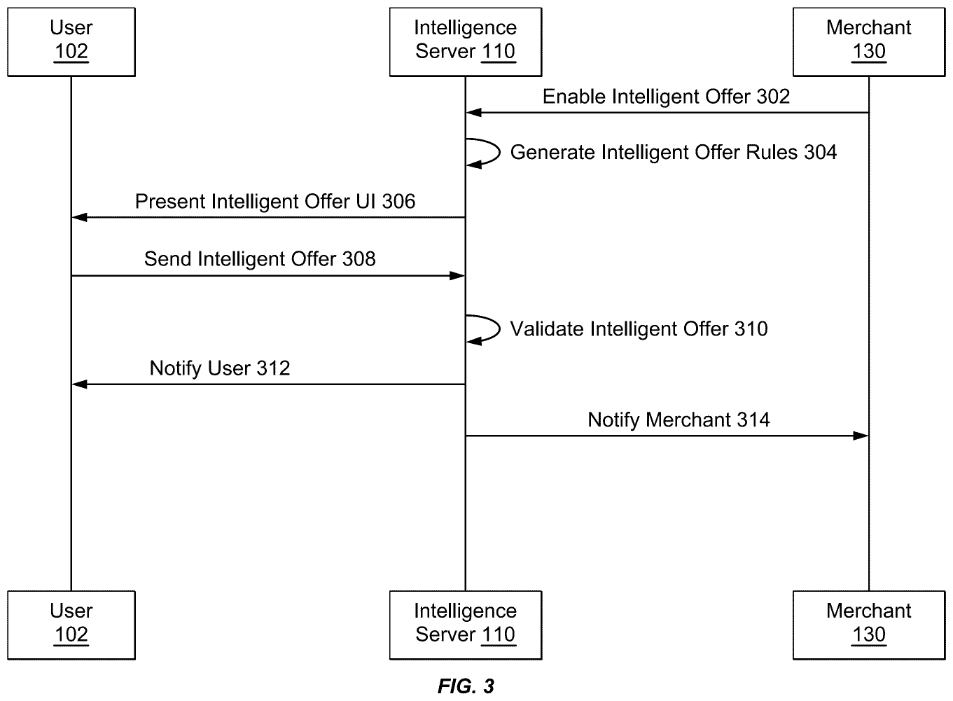

One or more techniques discussed below improve on these solutions by providing for a single intelligent offer from a customer to a merchant. In an embodiment, a merchant can select products for which a customer is permitted to make an intelligent offer. A given customer can make a single offer for these products, and the merchant either accepts or rejects the offer. This is discussed further, below, with regard to FIGS. 3-5.

In an embodiment, an intelligent offer approach provides significant technical advantages over a multi-round negotiation. For example, one or more embodiments discussed herein limit the network traffic between customers and merchants, by replacing multiple rounds of back and forth negotiations with a single intelligent offer. Further, one or more of these techniques reduces the computational burden on merchants, by limiting merchants to validating a single offer from a given customer for a given product or products.

One or more techniques discussed below can further improve on other solutions by efficiently using ML. For example, a merchant could validate a customer offer using a suitable ML model (e.g., a suitably trained ML model). In an embodiment, it is challenging for a merchant to determine whether to accept a given offer from a customer. In one embodiment, the merchant can use a rules-based approach in which the merchant provides parameters for offer acceptance (e.g., price bands, customer characteristics, and any other suitable parameters). This is discussed further, below, with regard to FIG. 3.

Alternatively, the merchant can use a suitable ML model to infer whether to accept a given offer. For example, the ML model can be trained on historical data (e.g., historical sales and offer data, or any other suitable data) to predict whether a merchant should accept or reject a given offer. This can provide for more accurate results, and can limit the network and computational burden required for a merchant to provide rules or guidelines for offer validation.

As a further alternative, or in addition, one or more embodiments described below provide for a combination of a rules based approach and ML for offer validation. In an embodiment, an ML model can be used to infer rules for offer validation (e.g., instead of, or in addition to, using an ML model to infer offer validation for individual offers). Combining rules and ML can provide significant technical advantages over a purely ML approach. For example, inference using an ML model is typically extremely computationally expensive. A solution that uses ML to decide whether to accept or reject each user offer could use large amounts of compute resources. One or more embodiments herein improve on this by combining a rules based technique and ML. For example, an ML model could be used to infer rules for offer acceptance, and then those rules could be applied to determine whether to accept or reject a given offer. This has significant technical advantages over alternative approaches, because it provides the accuracy advantages of ML assisted intelligent offer validation, while significantly reducing the number of ML inference computations and greatly reducing the computational burden.

Alternatively, or in addition, rules could be used for automatic acceptance or rejection of most offers, while inference using an ML model is used for intelligent acceptance or rejection of offers falling outside the defined rules. For example, an offer within 10% of a list price could be automatically accepted using a rule, an offer below 60% of a list price could be automatically rejected using a rule, and an offer between 60% and 75% of a list price could be accepted or rejected based on analyzing the offer using a suitable ML model. This approach also provides significant technical advantages by greatly reducing the computational resources compared with an approach that uses ML inference for all (or most) offers, while still providing the accuracy advantages of ML assisted intelligent offer validation.

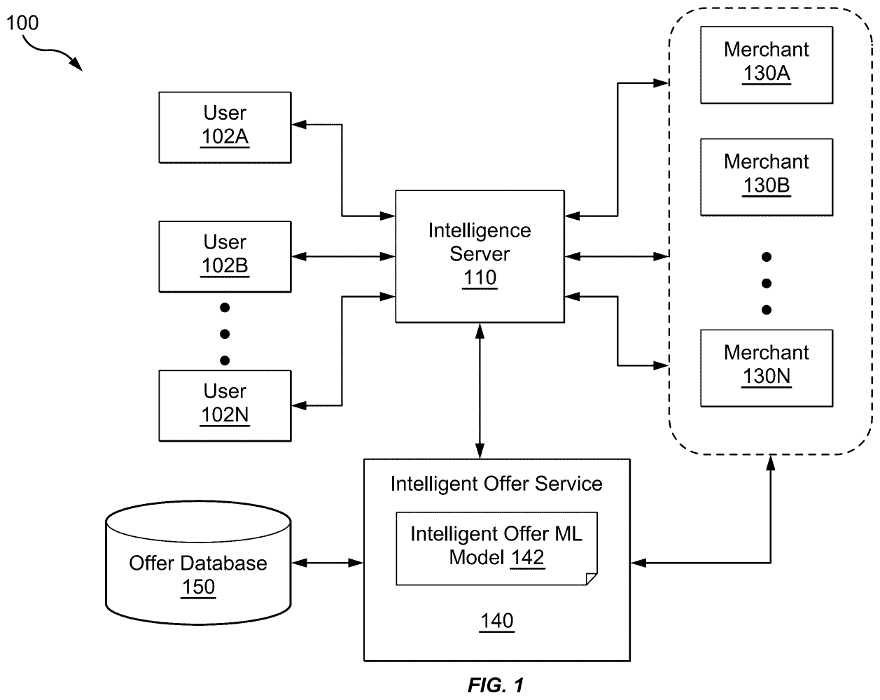

FIG. 1 illustrates a communication network 100 with intelligent offer validation, according to one embodiment. The communication network 100 includes a number of users 102A-N and a number of merchants 130A-N. In an embodiment, the users 102A-N are shoppers in an electronic commerce environment using an electronic communication device. The users can shop using any suitable communication device, including a computer, a smartphone, a tablet, or any other suitable device. In an embodiment, the users shop using a web browser, mobile application, or similar application.

In an embodiment, the merchants 130A-N are electronic purchase environments (e.g., electronic storefronts) for merchants selling products to the users 102A-N. Each merchant 130A-N can be an individual purchase environment (e.g., a webpage or mobile application for a particular merchant) or a multi-merchant purchase environment (e.g., a webpage or mobile application providing products from multiple merchants). In an embodiment, each merchant 130A-N hosts the electronic purchase environment in a suitable electronic environment (e.g., a web server hosting a webpage acting as an electronic storefront).

In an embodiment, the intelligence server 110 facilitates intelligent offer validation between the users 102A-N and the merchants 130A-N. For example, as discussed below in relation to FIGS. 3-5, a user 102A can use the intelligence server 110 to make an offer for a product provided by the merchant 130A. The merchant 130A can use the intelligence server 110 to validate the offer and determine whether to accept the offer.

Further, the intelligence server 110 can use the intelligent offer service 140 to identify rules and parameters for accepting (or denying) offers. For example, the intelligent offer service 140 can use an intelligent offer ML model 142 to infer rules or parameters for accepting offers from users. The intelligent offer ML model 142 can be a suitable supervised ML model trained using historical offer and sales information from the offer database 150. This is merely an example, and the intelligent offer ML model can be any suitable ML model.

Further, in an embodiment, the intelligence server 110 can record purchases by the users 102A-N for a given one or more merchants 130A-N using the offer database 150. The offer database 150 can be any suitable electronic database or electronic storage location, including a relational database, a non-relational database, a graph database, etc. Further, the offer database 150 can be a cloud storage location, a local storage location, a private remote storage location, etc. The offer database 150 can, for example, record that a given purchase was made by the user 102A from the merchant 130A, along with any offers made by the user 102A relating to the purchase. Further, the offer database 150 can record offers that did not lead to sales (e.g., offers from a user 102A to a merchant 130A that were not accepted by the merchant 130A or otherwise did not lead to a purchase).

In an embodiment, the various components illustrated in FIG. 1 communicate using one or more suitable communication networks, including the Internet, a wide area network, a local area network, or a cellular network, and uses any suitable wired or wireless communication technique (e.g., WiFi or cellular communication). Further, in an embodiment, the intelligence server 110, intelligent offer service 140, or both, can be implemented using any suitable combination of physical computing systems, including cloud compute nodes and storage locations or any other suitable implementation.

For example, the intelligence server 110, intelligent offer service 140, or both could be implemented using a server or cluster of servers (e.g., one or more on-premises servers). As another example, the intelligence server 110, intelligent offer service 140, or both can be implemented using a combination of compute nodes and storage locations in a suitable cloud environment. For example, one or more of the components of the intelligence server 110, intelligent offer service 140, or both can be implemented using a public cloud, a private cloud, a hybrid cloud, or any other suitable implementation.

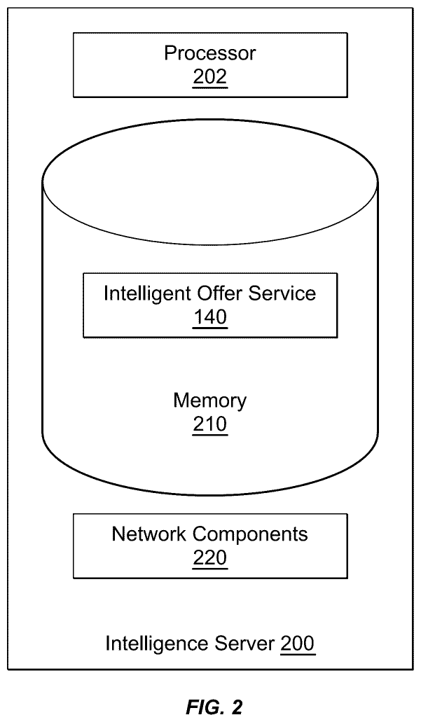

FIG. 2 is a block diagram illustrating an intelligence server 200 for intelligent offer validation, according to one embodiment. In an embodiment, the intelligence server 200 corresponds with the intelligence server 110 illustrated in FIG. 1. The intelligence server 200 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the intelligence server to interface with a communication network, as discussed above in relation to FIG. 1. For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the intelligence server 200. The program code is generally described as various functional “applications” or “modules” within the memory 210, although alternate implementations may have different functions and/or combinations of functions. Within the memory 210, the intelligent offer service 140 facilitates intelligent offer validation. This is discussed further below with regard to FIGS. 3-8.

Although FIG. 2 depicts the intelligent offer service 140 as located in the memory 210, that representation is merely provided as an illustration for clarity. More generally, the intelligence server 200 may include one or more computing platforms, such as computer servers for example, which may be co-located, or may form an interactively linked but distributed system, such as a cloud-based system (e.g., a public cloud, a private cloud, a hybrid cloud, or any other suitable cloud-based system). As a result, the processor 202 and memory 210 may correspond to distributed processor and memory resources within a computing environment.

FIG. 3 is a message diagram for intelligent offer validation, according to one embodiment. A merchant 130 (e.g., one of the merchants 130A-N illustrated in FIG. 1) transmits one or more network messages to an intelligence server 110 to enable an intelligent offer 302. For example, the merchant 130 can enable intelligent offers for any portion of the merchant's available products. The merchant 130 can enable intelligent offers for a particular product, a category of products, a group of products, all products, or any suitable combination of products. In an embodiment, the merchant 130 can enable intelligent offers using a suitable call through an application programming interface (API), a remote procedure call (RPC), a web browser, a mobile application, or using any other suitable technique.

At step 304, the intelligence server 110 generates intelligent offer rules. In an embodiment, the merchant 130 provides information about desired rules for intelligent offers for the associated products. For example, the merchant 130 can set rules to automatically accept or reject an intelligent offer from a user. These can include absolute pricing rules (e.g., offers within a range of values), relative pricing rules (e.g., within a percent or fraction of a listed price), or any other suitable rules. In an embodiment, analytics about prior purchases, prior offers, or any other suitable data, can further be used to generate intelligent offer rules.

Further, the rules can be tailored for different users or different categories of users. As one example, returning users or users belonging to a loyalty program may have a wider range of offers accepted. As another example, user characteristics can be used to generate the intelligent offer rules (e.g., user purchase history, user location, user identifier (e.g., internet protocol (IP) address) user method of payment, or any other suitable characteristics).

In an embodiment, the intelligence server 110 can use ML to generate intelligent offer rules. For example, the intelligence server 110 can use an intelligent offer service (e.g., the intelligent offer service 140 illustrated in FIG. 1) and an intelligent offer ML model (e.g., the intelligent offer ML model 142 illustrated in FIG. 1). The intelligent offer ML model can be any suitable ML model. For example, the intelligent offer ML model can be a suitable supervised ML model trained using historical transaction data (e.g., offer and purchase data). In one embodiment, the intelligent offer ML model is trained to infer whether to accept an offer from a user for a product. Alternatively, or in addition, the intelligent offer ML model is trained to infer intelligent offer rules, and the intelligence server 110 applies the rules for a given user and purchase.

In one embodiment, the intelligent offer rules are used by the intelligence server 110 to automatically accept or reject offers (e.g., without human intervention). Alternatively, or in addition, the intelligent offer rules assist in allowing for human acceptance or rejection of an offer. For example, the intelligent offer rules can define some offers for automatic acceptance (e.g., within a particular fraction of the list price for a product), others for automatic rejection (e.g., below a threshold fraction of the list price), and others for manual review and acceptance or rejection. As another example, the intelligent offer rule can define some offers for automatic acceptance, others for automatic rejection, and others for inference using the intelligent offer ML model.

As discussed above, in an embodiment combining rules and ML can provide significant technical advantages. For example, the intelligent offer ML model could be used to infer rules for offer acceptance, and then those rules could be applied to determine whether to accept or reject a given offer. This has significant technical advantages over alternative approaches, because it provides the accuracy advantages of ML assisted intelligent offer validation, while significantly reducing the number of inference actions and greatly reducing the computational burden. Further, rules could be used for automatic acceptance or rejection of most offers, while inference using an ML model is used for intelligent acceptance or rejection of offers falling outside the defined rules. This approach also provides significant technical advantages by greatly reducing the computational resources compared with an approach that uses ML inference for all (or most) offers, while still providing the accuracy advantages of ML assisted intelligent offer validation.

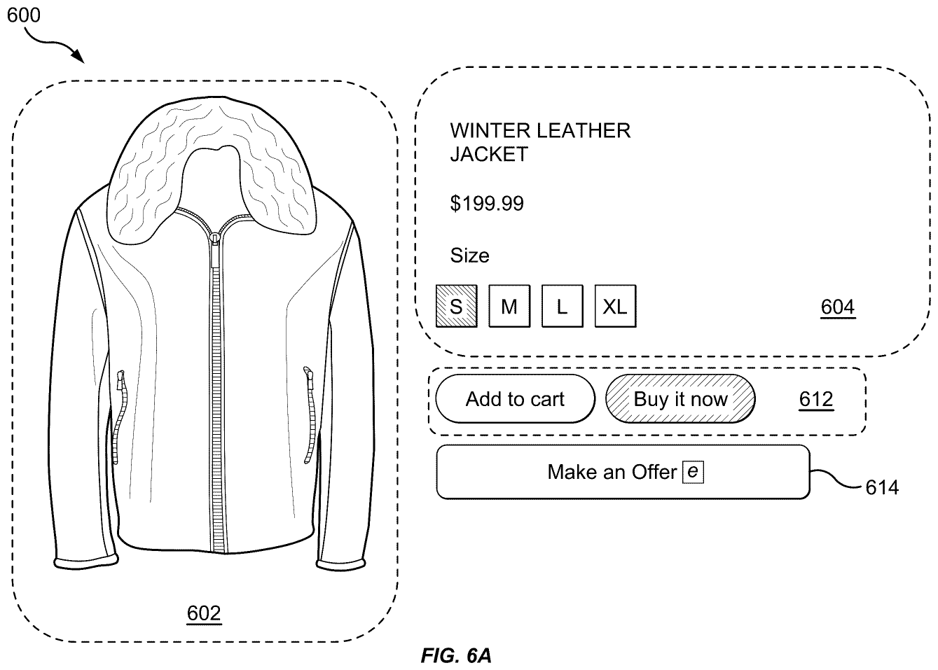

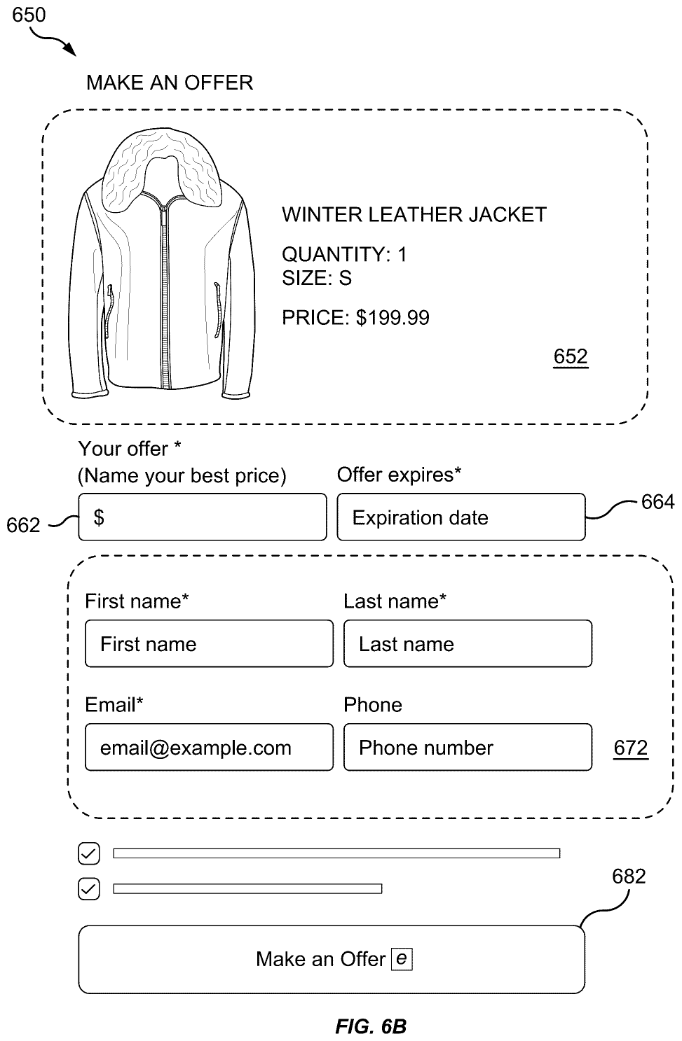

At step 306 the intelligence server 110, or any other suitable server or software interface (e.g., a web server) presents an intelligent offer UI to a user 102. In an embodiment, the UI is a hypertext markup language (HTML) UI presented to the user 102 through a web browser, mobile application, or any other suitable technique. FIGS. 6A-B provide an example intelligent offer UI. This is merely an example, and the intelligent offer UI can be any suitable visual interface, audio interface (e.g., a voice interface), or any other suitable interface.

At step 308 the user 102 sends the intelligent offer to the intelligence server 110. For example, the user 102 can complete an HTML form presenting the offer amount, expiration, and any other suitable information. This is discussed further, below, with regard to FIGS. 6A-B. This is merely an example, and the user 102 can send the intelligent offer using any suitable technique.

In an embodiment, the intelligent offer is the sole offer from the user 102. For example, the intelligence server 110 can validate the intelligent offer based only on the intelligent offer provided at step 308, without any additional negotiation. In an embodiment, the intelligence server 110 bars the user 102 from providing further offers for the target product (e.g., for a pre-determined period of time). As discussed above, this has numerous technical advantages over an approach with multiple rounds of negotiation between the user 102 and the merchant 130, including saving network transmission resources and computational resources (e.g., for the intelligence server 110). In some instances, even though the user 102 is prompted or encouraged to provide only one offer, the intelligence server 110 does not prevent the user 102 from providing more or additional offers.

At step 310 the intelligence server 110 validates the intelligent offer. For example, as discussed above in relation to step 304, the intelligence server 110 can generate intelligent offer rules. The intelligence server 110 can then compare the intelligent offer rules to the intelligent offer provided by the user 102, and can determine whether to accept or reject the offer. For example, the intelligent offer service can use the offer price to determine whether to accept or reject the offer, and can use an offer expiration to determine whether the offer is still valid. Alternatively, or in addition, as discussed above the intelligence server 110 can use an intelligent offer ML model to infer whether to accept or reject an offer (e.g., instead of, or in addition to, using a rules based approach).

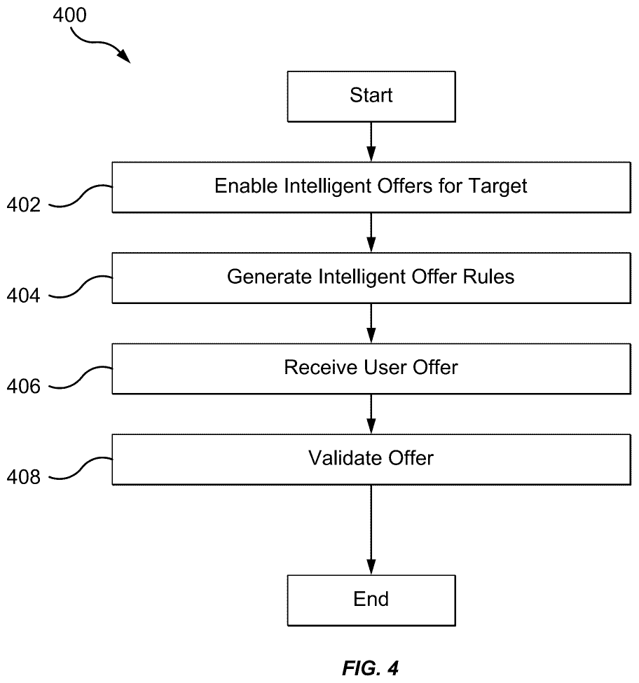

At step 312 the intelligence server notifies the user whether the offer is accepted or rejected. As discussed below in relation to FIG. 4, in an embodiment the intelligent offer reflects the only offer permitted by the user, and is either accepted or rejected by the intelligence server 110. At step 314 the intelligence server 110 notifies the merchant 130 (e.g., whether the offer has been accepted or rejected).

FIG. 4 is a flowchart 400 illustrating intelligent offer validation, according to one embodiment. In an embodiment, the flowchart 400 corresponds with actions taken by the intelligence server 110 illustrated in FIG. 3. At block 402, an intelligent offer service (e.g., the intelligent offer service 140 illustrated in FIGS. 1-2) enables intelligent offers for a target. In an embodiment, a merchant (e.g., the merchant 130 illustrated in FIG. 3) decides to enable intelligent offers for a target product, category of products, group of products, or any other suitable target. For example, as illustrated in FIG. 3, the merchant can transmit a network message to enable intelligent offers for the target.

In an embodiment, the intelligent offer service receives the network message from the merchant and enables intelligent offers for the target. For example, the intelligent offer service can set a suitable value in an electronic database indicating that intelligent offers are enabled for the target. This is merely an example, and the intelligent offer service can use any suitable technique.

At block 404, the intelligent offer service generates intelligent offer rules. In an embodiment, as discussed above in relation to step 304 illustrated in FIG. 3, the merchant provides information about desired rules for intelligent offers for the associated product or products (e.g., rules to automatically accept or reject an intelligent offer from a user, rules to assist in allowing for human acceptance or rejection of an offer, or any other suitable rules). The intelligent offer service can generate rules from the information provided by the merchant (e.g., using ML, using an algorithmic approach, or using any other suitable technique).

At block 406, the intelligent offer service receives a user offer. In an embodiment, as discussed above with regard to step 308 illustrated in FIG. 3, a user can provide an offer to an intelligence server (e.g., using a communication network). For example, a user can enter an offer into a suitable UI. This is discussed further below, with regard to FIG. 6. In an embodiment, as discussed above, the user offer is the sole offer from that user. For example, the intelligent offer service can bar the user from providing additional offers for the target product (e.g., for a pre-determined period of time).

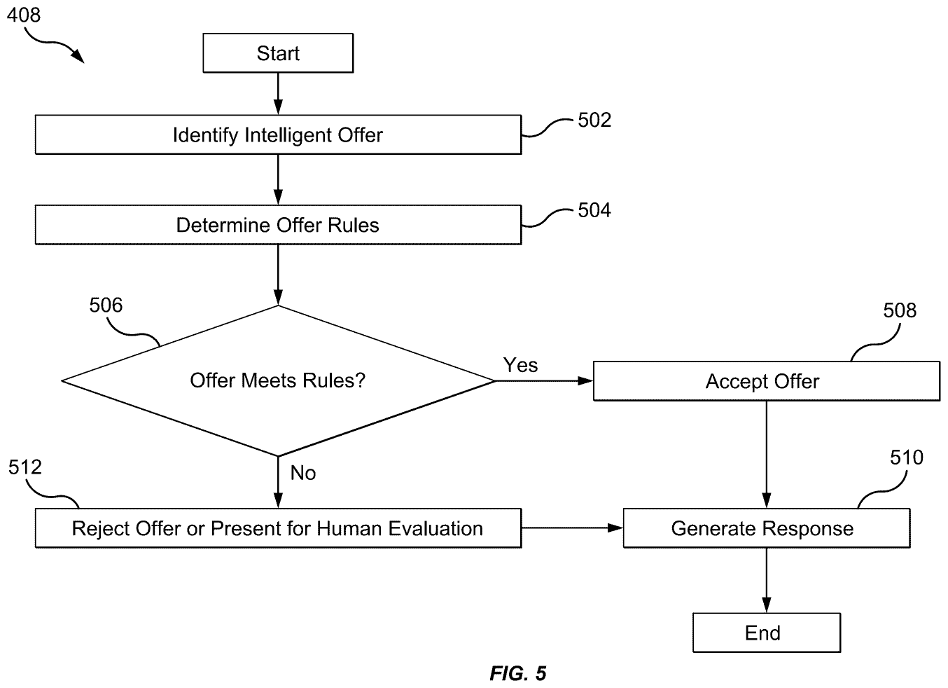

At block 408, the intelligent offer service validates the offer. In an embodiment, as discussed above in relation to step 310, the intelligent offer service can compare the intelligent offer rules (e.g., generated at block 404) to the intelligent offer (e.g., received at block 406). The intelligent offer service can determine whether to accept or reject the offer (e.g., based on price, expiration, and any other suitable offer characteristics). This is discussed further, below, with regard to FIG. 5. Alternatively, or in addition, the intelligent offer service can use a suitable ML model to infer whether to accept or reject an offer (e.g., instead of, or in addition to, using a rules based approach).

FIG. 5 is a flowchart illustrating validating an offer for intelligent offer validation, according to one embodiment. In an embodiment, FIG. 5 corresponds with block 408 illustrated in FIG. 4. At block 502 an intelligent offer service (e.g., the intelligent offer service 140 illustrated in FIGS. 1-2) identifies an intelligent offer. For example, as discussed above in relation to block 406 illustrated in FIG. 4, a user can provide an offer using a suitable UI, and the offer can be transmitted from the user to the intelligent offer service using a suitable communication network.

At block 504, the intelligent offer service determines offer rules. In an embodiment, as discussed above in relation to block 404 illustrated in FIG. 4, the intelligent offer service generates intelligent offer rules for the target product or products. For example, the merchant can provide information about desired rules for intelligent offers for the associated product or products (e.g., rules to automatically accept or reject an intelligent offer from a user, rules to assist in allowing for human acceptance or rejection of an offer, or any other suitable rules). The intelligent offer service can generate rules from the information provided by the merchant (e.g., using ML, using an algorithmic approach, or using any other suitable technique).

At block 506, the intelligent offer service determines whether the offer meets the rules. In an embodiment, the intelligent offer service compares the offer with the offer rules, and determines whether to automatically accept the offer, automatically reject the offer, provide the offer for human evaluation, or take any other suitable action. Alternatively, or in addition, the intelligent offer service uses a suitable ML model (e.g., a trained supervised ML model) to infer whether to accept or reject the offer, or present the offer for human evaluation.

If the intelligent offer service determines to accept the offer (e.g., accept the offer automatically without human intervention), the flow proceeds to block 508. At block 508 the intelligent offer service accepts the offer. At block 510, the intelligent offer service generates a response indicating the acceptance. For example, the intelligent offer service can transmit a response to the merchant, user, or both, indicating acceptance of the offer.

Returning to block 506, if the intelligent offer service determines not to automatically accept the offer, the flow proceeds to block 512. At block 512 the intelligent offer service rejects the offer or presents the offer for human evaluation. At block 510 the intelligent offer service generates a response indicating the rejection or requesting human evaluation.

For example, at block 506 the intelligent offer service can determine based on offer rules to automatically reject the offer. At block 512, the intelligent offer service rejects the offer, and at block 510 the intelligent offer service generates a response indicating the rejection (e.g., a response to the user, to the merchant, or both).

As another example, at block 506 the intelligent offer service can determine based on offer rules to present the offer for human evaluation. At block 512, the intelligent offer service presents the offer for human evaluation. For example, at block 510 the intelligent offer service can generate a suitable UI soliciting a response, and provide the UI to a designated destination for human evaluation (e.g., to a designated destination associated with the merchant, so that the merchant can evaluation whether to accept the offer).

FIG. 6A illustrates a UI 600 for intelligent offer validation, according to one embodiment. In an embodiment, the UI 600 is an example of an intelligent offer UI presented to a user, as discussed above in relation to step 306 illustrated in FIG. 3. As shown in FIG. 6A, in an embodiment a product for sale (e.g., a clothing item in the illustrated example) is presented using an image 602 and a number of characteristics 604 (e.g., name, store location, size, color, price, or any other suitable characteristics). A user (e.g., the user 102 illustrated in FIG. 3) can add the product to a cart or buy it now, using the buttons 612.

Further, the user can determine to make an intelligent offer for the product, by selecting the button 614. In an embodiment, selecting the button 614 transitions the user to the UI 650 illustrated in FIG. 6B. The UI 650 includes product information 652 (e.g., an image, name, characteristics, price, or any other suitable information). The user can enter an offer 662 and an expiration for the offer 664. The UI 650 may include wording that encourages the user to provide their best offer or price. The user can further enter biographical information 672 (e.g., name, e-mail address, phone number, or any other suitable information). The user can the select a make an offer button 682. In an embodiment, selecting the make an offer button 682 initiates step 308 illustrated in FIG. 3, and the user transmits the offer to an intelligence server (e.g., the intelligence server 110 illustrated in FIG. 3).

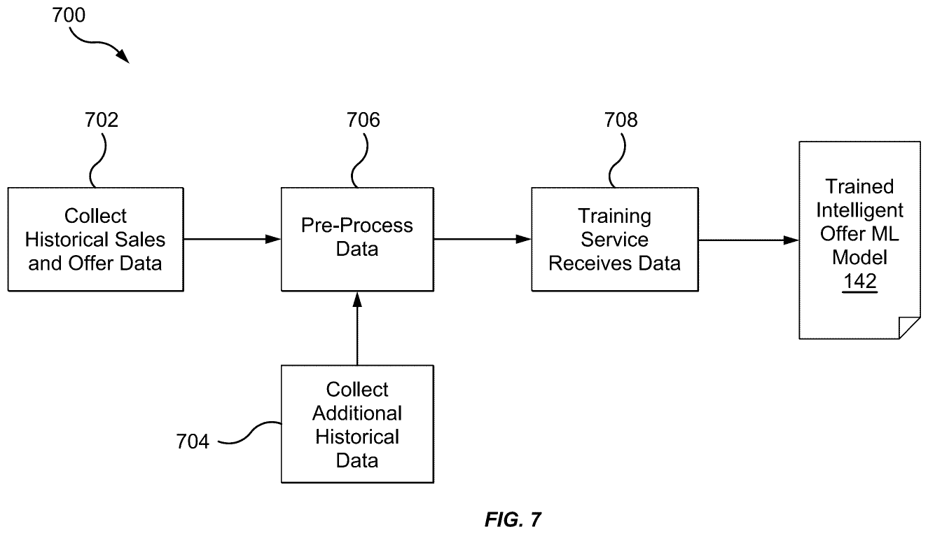

FIG. 7 is a flowchart 700 illustrating training an intelligent offer ML model, according to one embodiment. This is merely an example, and in an embodiment a suitable unsupervised technique could be used (e.g., without requiring training). At block 702, a training service (e.g., a human administrator or a software or hardware service) collects historical sales and offer data. For example, an intelligent offer service (e.g., the intelligent offer service 140 illustrated in FIG. 1) can be configured to act as a training service, and can collect historical data reflecting sales and offers for items (e.g., gathered over time). This historical data can be maintained per merchant (e.g., to avoid co-mingling potentially sensitive data between merchants), per product, per product category, or using any other suitable technique.

At block 706, the training service (or other suitable service) pre-processes the collected historical sales and offer data. For example, the training service can create feature vectors reflecting the values of various features, for each product, product category, merchant, or any other suitable delineation. At block 708, the training service receives the feature vectors and uses them to train a trained intelligent offer ML model 142.

In an embodiment, at block 704 the training service also collects additional historical data. For example, the training service can use prior user feedback data (e.g., surveys and other suitable reflections of user feedback for prior offers or sales), market trend data (e.g., reflecting macro or micro economic or sales trends), inventory data (e.g., reflecting available inventory for a given product, product category, merchant, or any other suitable delineation), and any other suitable data.

At block 706, the training service can also pre-process this additional historical data. For example, the feature vectors corresponding to the historical sales and offer data can be further annotated using the additional historical data. Alternatively, or in addition, additional feature vectors corresponding to the additional historical data can be created. At block 708, the training service uses the pre-processed additional historical data during training to generate the trained intelligent offer ML model 142.

In an embodiment, the pre-processing and training can be done as batch training. In this embodiment, all data is pre-processed at once (e.g., all historical sales and offer data and additional historical data), and provided to the training service at block 708. Alternatively, the pre-processing and training can be done in a streaming manner. In this embodiment, the data is streaming, and is continuously pre-processed and provided to the training service. For example, it can be desirable to take a streaming approach for scalability. The set of training data may be very large, so it may be desirable to pre-process the data, and provide it to the training service, in a streaming manner (e.g., to avoid computation and storage limitations). Further, in an embodiment, a federated learning approach could be used in which multiple entities contribute to training a shared model.

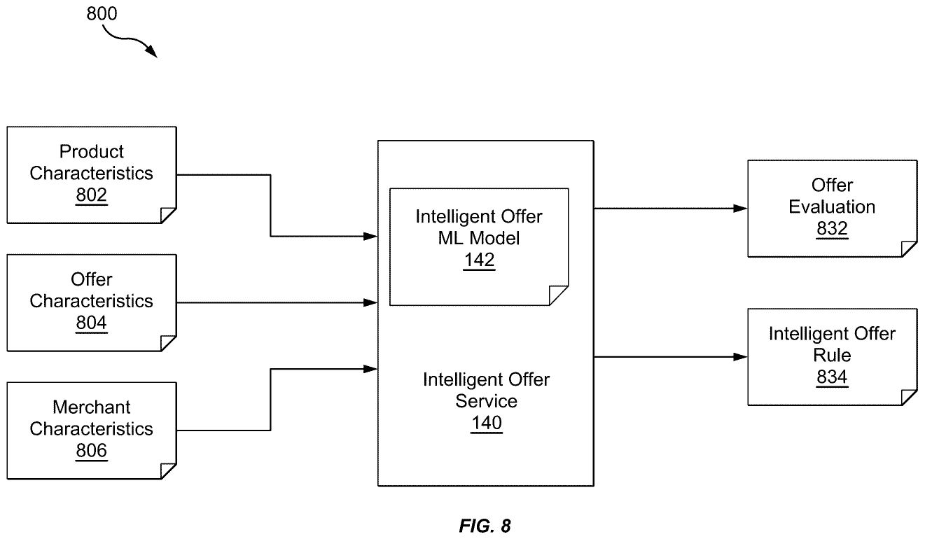

FIG. 8 is a flowchart 800 illustrating inferring an intelligent offer using an ML model, according to one embodiment. An intelligent offer service 140, as discussed above in relation to FIG. 1, is associated with an intelligent offer ML model 142. In an embodiment, the intelligent offer ML model 142 is trained to predict an offer evaluation 832 (e.g., whether to accept a given offer), an intelligent offer rule (e.g., a rule used to determine whether to accept a future offer), or any other suitable inference. This is discussed above in relation to FIGS. 3-4. For example, the intelligent offer ML model can predict whether to accept or reject a given offer. As another example, the intelligent offer ML model can predict a rule to be used to accept or reject a future offer.

In an embodiment, the intelligent offer service 140 uses multiple types of data to predict an offer evaluation 832 or an intelligent offer rule 834. For example, the intelligent offer service 140 can use product characteristics 802 (e.g., data relating to the relevant product), offer characteristics 804 (e.g., data relating to an offer made by a user), merchant characteristics 806 (e.g., data relating to a merchant offering the product for sale), or any other suitable data. The intelligent offer service 140 can use the intelligent offer ML model 142 to infer (e.g., predict) an offer evaluation 832, an intelligent offer rule 834, or both.

In an embodiment, the offer evaluation 832, intelligent offer rule 834, or both, reflect a single best prediction. Alternatively, or in addition, the offer evaluation 832, intelligent offer rule 834, or both, identify multiple suggested matches. In an embodiment, the user can the select a preferred option among the multiple suggested matches, one or more rules could be used to select among options, or any other suitable technique can be used.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
enabling intelligent offers for a target product;
identifying one or more intelligent offer rules for the target product;
receiving, from a user over a communication network, an offer for the target product; and
validating the offer for the target product using the one or more intelligent offer rules, comprising:
determining to accept the offer for the target product based on comparing the intelligent offer rules to one or more characteristics of the offer; and
accepting the offer,
wherein the offer for the target product is the sole offer from the user for the target product, and
wherein the determining to accept the offer for the target product is based on the sole offer from the user for the target product.

2. The method of claim 1, wherein the one or more intelligent offer rules are generated automatically, without human intervention, based on information provided by a merchant for the target product.

3. The method of claim 2, wherein a first intelligent offer rule, of the one or more intelligent offer rules, is generated by inferring the offer rule using a machine learning (ML) model.

4. The method of claim 3, wherein the ML model is a supervised ML model trained using historical data to infer intelligent offer rules for target products.

5. The method of claim 1, wherein the user is barred from providing additional offers for the target product for a pre-determined period of time.

6. The method of claim 1, wherein the one or more intelligent offer rules designate a first one or more offer characteristics for which the intelligent offer is automatically accepted without human intervention and a second one or more offer characteristics for which the intelligent offer is rejected without human intervention.

7. The method of claim 6, wherein the one or more intelligent offer rules further designate a third one or more offer characteristics for which the intelligent offer is evaluated using an ML model.

8. The method of claim 7, wherein the ML model is a supervised ML model trained using historical data to infer whether to accept or reject the offer for the target product.

9. A non-transitory computer program product comprising:
one or more non-transitory computer readable media containing, in any combination, computer program code that, when executed by operation of any combination of one or more processors, performs operations comprising:
enabling intelligent offers for a target product;
identifying one or more intelligent offer rules for the target product;
receiving, from a user over a communication network, an offer for the target product; and
validating the offer for the target product using the one or more intelligent offer rules, comprising:
determining to accept the offer for the target product based on comparing the intelligent offer rules to one or more characteristics of the offer; and
accepting the offer,
wherein the offer for the target product is the sole offer from the user for the target product, and
wherein the determining to accept the offer for the target product is based on the sole offer from the user for the target product.

10. The non-transitory computer program product of claim 9, wherein the one or more intelligent offer rules are generated automatically, without human intervention, based on information provided by a merchant for the target product.

11. The non-transitory computer program product of claim 10, wherein a first intelligent offer rule, of the one or more intelligent offer rules, is generated by inferring the offer rule using a machine learning (ML) model.

12. The non-transitory computer program product of claim 9, wherein the user is barred from providing additional offers for the target product for a pre-determined period of time.

13. The non-transitory computer program product of claim 9, wherein the one or more intelligent offer rules designate a first one or more offer characteristics for which the intelligent offer is automatically accepted without human intervention and a second one or more offer characteristics for which the intelligent offer is rejected without human intervention.

14. The non-transitory computer program product of claim 13, wherein the one or more intelligent offer rules further designate a third one or more offer characteristics for which the intelligent offer is evaluated using an ML model.

15. A system, comprising:
one or more processors; and
one or more memories storing a program, which, when executed on any combination of the one or more processors, performs operations, the operations comprising:
enabling intelligent offers for a target product;
identifying one or more intelligent offer rules for the target product;
receiving, from a user over a communication network, an offer for the target product; and
validating the offer for the target product using the one or more intelligent offer rules, comprising:
determining to accept the offer for the target product based on comparing the intelligent offer rules to one or more characteristics of the offer; and
accepting the offer,
wherein the offer for the target product is the sole offer from the user for the target product, and
wherein the determining to accept the offer for the target product is based on the sole offer from the user for the target product.

16. The system of claim 15, wherein the one or more intelligent offer rules are generated automatically, without human intervention, based on information provided by a merchant for the target product.

17. The system of claim 16, wherein a first intelligent offer rule, of the one or more intelligent offer rules, is generated by inferring the offer rule using a machine learning (ML) model.

18. The system of claim 15, wherein the user is barred from providing additional offers for the target product for a pre-determined period of time.

19. The system of claim 15, wherein the one or more intelligent offer rules designate a first one or more offer characteristics for which the intelligent offer is automatically accepted without human intervention and a second one or more offer characteristics for which the intelligent offer is rejected without human intervention.

20. The system of claim 19, wherein the one or more intelligent offer rules further designate a third one or more offer characteristics for which the intelligent offer is evaluated using an ML model.
